(19) United States
(12) Patent Application Publication
(10) Pub. No.: US 2026/0036524 A1
(43) Pub. Date: Feb. 5, 2026

(54) DUST INSPECTION DEVICE

(71) Applicant: KANAUE APPLIED MATERIALS CORP., Tainan City (TW)

(72) Inventors: WEI-MING HUANG, Tainan City (TW); MING-ZHANG DING, Tainan City (TW)

(21) Appl. No.: 19/288,617

(22) Filed: Aug. 1, 2025

(30) Foreign Application Priority Data
Aug. 5, 2024 (TW) 113129198

(51) Int. Cl. G01N 21/94; G01N 21/88

(52) U.S. Cl. CPC G01N 21/94; G01N 21/8803; G01N 21/8806

(57) ABSTRACT

A dust inspection device includes: a light-emitting module outputting light travelling in a light-emitting direction; and a frame, wherein the light-emitting module is installed on the frame. The light forms an optical net in a space surrounded by the frame and the light-emitting module, wherein dust passing through the optical net reflects the light to a user's eye, so that the user can inspect the dust in an environment using the dust inspection device.

### CROSS-REFERENCE TO RELATED APPLICATIONS

This application claims priority of No. 113129198 filed in Taiwan R.O.C. on Aug. 5, 2024 under 35 USC 119, the entire contents of which are hereby incorporated by reference.

### FIELD OF THE INVENTION

This disclosure relates to a dust inspection device, and more particularly to a dust inspection device facilitating a user (or an operator) in inspecting or checking dust in a space.

### DESCRIPTION OF RELATED ART

In modern manufacturing processes, cleanrooms play an extremely critical role in preventing dust contamination of silicon wafers, glass substrates and other materials, thereby improving the product yield and stability. As manufacturing technology continues to advance, the requirements of the manufacturing processes on the cleanliness get higher and higher. Therefore, it's necessary to improve the cleanroom environments to support applications of advanced manufacturing technologies, promote technological innovation, and drive development.

Monitoring dust levels in cleanrooms is crucial for maintaining the cleanliness thereof. Conventional methods for checking dust levels include using fallout counters, laser particle counters, air dust counters, sedimentation plates, surface cleanliness tests, optical microscopy, electron microscopy and the like. However, these testing methods are suitable for long-term monitoring and require the complex and expensive equipment to accurately measure the dust levels. Therefore, they are not ideal for real-time monitoring.

### SUMMARY OF THE INVENTION

It is therefore an objective of this disclosure to provide a dust inspection device capable of immediately inspecting or checking dust, and an operator can use this inspection device to immediately detect a distribution state of dust within the space. For example, the operator can grip and swing this inspection device to immediately detect the distribution state of the dust within the space.

To achieve the above-identified objective, this disclosure provides a dust inspection device including: a light-emitting module outputting light travelling in a light-emitting direction; and a frame, wherein the light-emitting module is installed on the frame. The light forms an optical net in a space surrounded by the frame and the light-emitting module, wherein dust passing through the optical net reflects the light to a user's eye, so that a user uses this dust inspection device to inspect the dust in an environment.

With the above-mentioned embodiment, a user can utilize this dust inspection device to immediately inspect the state of dust within the space and provide immediate reference for checking or improving the cleanliness of cleanrooms.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a pictorially exploded view showing a dust inspection device according to a preferred embodiment of this disclosure.

FIG. 2 is an exploded top view showing the dust inspection device of FIG. 1.

FIG. 3 is an assembled and schematic top view showing the dust inspection device of FIG. 1.

FIG. 4 is a schematic view showing work principles of the dust inspection device of FIG. 1.

FIGS. 5 to 8 are schematic front views showing work principles of other examples of the dust inspection device of FIG. 1.

FIG. 9 is a schematic view showing a modified example of the dust inspection device of FIG. 1.

FIG. 10 is a schematic view showing another modified example of the dust inspection device of FIG. 1.

### DETAILED DESCRIPTION OF THE INVENTION

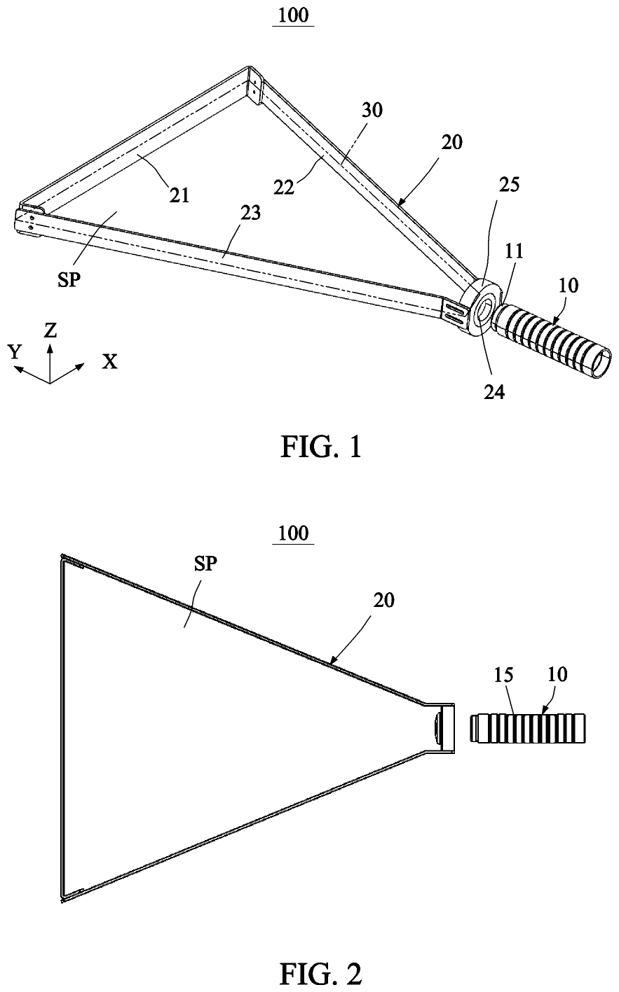

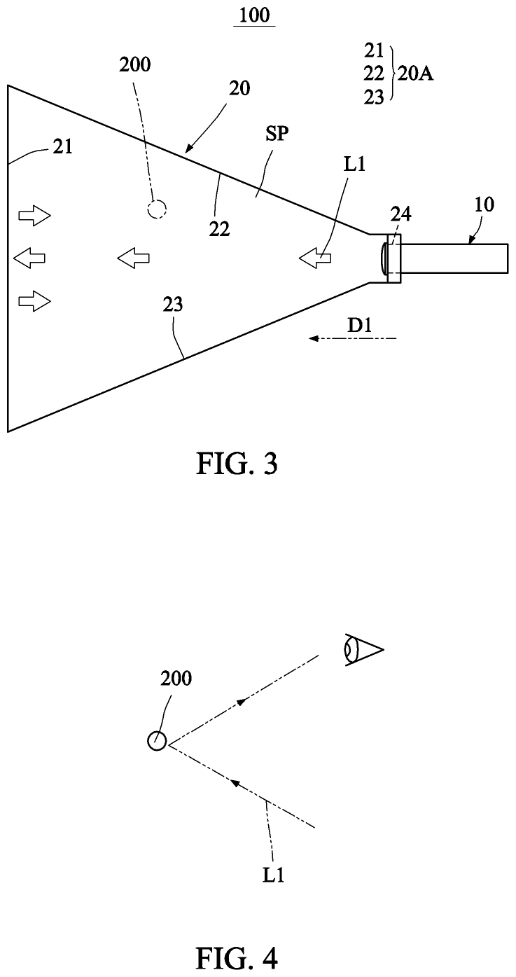

FIG. 1 is a pictorially exploded view showing a dust inspection device 100 according to a preferred embodiment of this disclosure. FIGS. 2 and 3 are respectively an exploded top view and an assembled and schematic top view showing the dust inspection device 100 of FIG. 1. FIG. 4 is a schematic view showing work principles of the dust inspection device 100 of FIG. 1. Referring to FIGS. 1 to 4, the dust inspection device 100 includes a light-emitting module 10 and a frame 20.

The light-emitting module 10 outputs light L1 travelling in a light-emitting direction D1 (a direction away from the user in this non-restrictive example). In one example, the light is linear light, and may be implemented by a light source and a lens of the dust inspection device converting light rays of the light source into straight parallel light. In another example, the light is fan-shaped light, and may be implemented by the light source and the lens converting light rays of the light source into diverging fan-shaped light. The light source includes, for example but without limitation to, a laser source or a visible light source. The light-emitting module 10 can be manufactured in the shape of a flashlight, making it convenient for the user to hold and turn the light source on or off. Furthermore, its elongated shape facilitates the placement of optical components, such as the lens, within the light-emitting module 10 to produce the desired light. The above-mentioned dust inspection device 100 may be referred to as a laser dust inspection kit. In another example, the frame 20 can be designed to be easily held by the user, and the light-emitting module 10 is directly mounted on the frame 20. In still another example, the frame 20 can be designed with a gripping structure 15 to be conveniently held by the user so that the user can swing the dust inspection device 100 by the gripping structure 15 for immediate inspection. The light-emitting module 10 is directly mounted to the frame 20, so that the frame 20 and the light-emitting module 10 can be combined more stably and conveniently. In still another example, the color of light L1 is yellow-green, green, or blue-purple, allowing the human eye to more sensitively detect whether dust has passed through.

The light-emitting module 10 is mounted on the frame 20. The light L1 forms an optical net 30 in a space SP surround by the frame 20 and the light-emitting module 10. The user can hold the light-emitting module 10, turn on the light source and move (swing) the frame 20, so that dust 200 passing through the optical net 30 reflects the light L1 to the user's eye, and the user can inspect the dust in the environment in a manner of holding the dust inspection device 100 by his/her hand. If there is no dust passing through the optical net 30, then the user will not notice any reflected light from the dust. Therefore, by utilizing the optical path of the light L1 from the light-emitting module 10 to the dust 200 and then to the eye in conjunction with the user's holding and swinging of the dust inspection device 100, the eye can see whether the dust is present or not, and the real-time dust inspection can be achieved.

The above-mentioned inspection does not relate to counting of the number of the dust particles, but rather observing whether or not any dust passes through the optical net 30. If there are dust particles passing through the optical net 30, then it represents that the dust is present in the cleanroom. The user can swing or wave the dust inspection device 100 at different locations, and thus immediately detect the presence or absence of dust, allowing for further improvements to the cleanroom. This is suitable for apparatus maintenance in the cleanroom after the apparatus has started, and also for on-the-spot checks by general operators after entering the cleanroom.

The light L1 travels in the light-emitting direction D1 to form the optical net 30. The frame 20 mainly restricts the range of the optical net 30 and prevents the laser beam from directly incident to other positions, such as eyes of another operator or any other apparatus that can affected by the laser beam. However, the inner surface of the frame 20 may also be configured into a reflective surface. In this case, the frame 20 has an inner reflective structure 20A which reflects the light L1 and the reflected light L travels in the space SP. In a top view (looking in the negative Z direction of FIG. 1), the inner reflective structure 20A is polygonal (substantially triangular in this example). Therefore, the frame 20 has a substantial triangular shape, and a first end 11 of the light-emitting module 10 is disposed on a vertex of the substantially triangular shape.

The frame 20 has a first reflective surface 21, a second reflective surface 22 and a third reflective surface 23. The first end 11 of the light-emitting module 10 is disposed in a mounting hole 24 formed on a connection portion 25 of the second reflective surface 22 and the third reflective surface 23. In addition, the light-emitting direction D1 is a direction from the mounting hole 24 to the first reflective surface 21.

The above-mentioned example is explained based on the user holding the dust inspection device. In other examples, however, the dust inspection device may also be mounted on the ground, the wall, the machine or any other structure, and the user can manually turn on or off the light source of the light-emitting module, or the light source of the light-emitting module is configured to turn on for a long time (e.g., the light source is turned on when work is performed in the cleanroom), so that the user can immediately visually inspect whether the dust has passed through the dust inspection device or not. In one example, the user can immediately check whether dust is brought in or generated when a cart, an operator or he (or she) passes by.

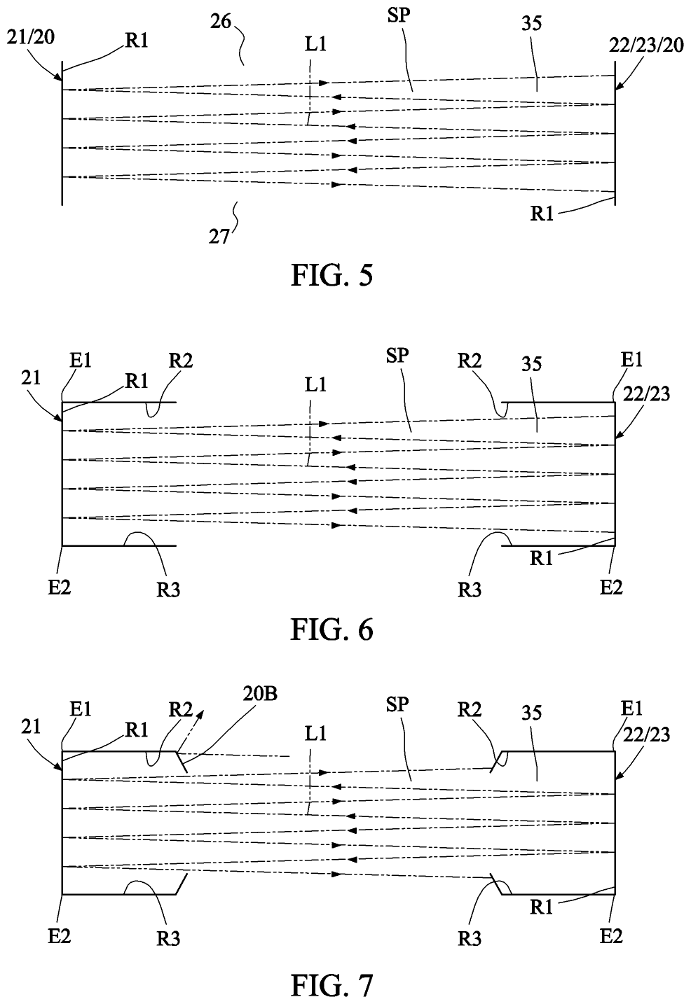

FIGS. 5 to 8 are schematic front views showing work principles of other examples of the dust inspection device of FIG. 1. Referring to FIGS. 3 and 5, the first reflective surface 21 reflects the light L1 partially to the second reflective surface 22 and the third reflective surface 23, and partially to the connection portion 25. The second reflective surface 22 and the third reflective surface 23 also reflect the light in different directions, so that light interleaving within the overall optical net 30 becomes denser. Because the optical path is complicated, the first reflective surface 21 is regarded as a left-side reflective surface, and the second reflective surface 22 and the third reflective surface 23 are regarded as a right-side reflective surface in FIG. 5 for the sake of explanation. Those skilled in the art may easily understand that this disclosure is not limited thereto.

Referring to FIG. 5, the first reflective surface 21 reflects the light L1 to the second reflective surface 22 and the third reflective surface 23. After the light L1 has been repeatedly reflected by the first reflective surface 21, the second reflective surface 22 and the third reflective surface 23, the optical net 30 is extended in a top view direction to generate an optical detection space 35 having a predetermined thickness, and to increase an opportunity that the user senses the dust 200. That is, when the optical net 30 forms only one plane, the dust may not be sensed because it only passes through the plane in a very short period of time. When the optical net 30 has a certain thickness, the dust passes through the optical net 30 for a longer time and thus can be easily sensed. Referring to FIGS. 1 to 5, the frame 20 has a first opening 26 and a second opening 27 disposed opposite the first opening 26. Because the dust 200 passes through the optical net 30, the dust 200 may enter the optical net 30 from the first opening 26, and the dust 200 passing through the optical net 30 reflects the light to the user's eye through the first opening 26 or the second opening 27, and then the dust 200 leaves the optical net 30 and the frame 20 from the second opening 27.

Referring to FIG. 6, each of the first reflective surface 21, the second reflective surface 22 and the third reflective surface 23 includes a vertical reflective surface R1, a first horizontal reflective surface R2 and a second horizontal reflective surface R3. The first horizontal reflective surface R2 and the second horizontal reflective surface R3 are respectively connected to an upper edge E1 and a lower edge E2 of the vertical reflective surface R1. The first horizontal reflective surface R2 and the second horizontal reflective surface R3 restrict a portion of light L1 from leaving the space SP and directly travelling to the user's eye.

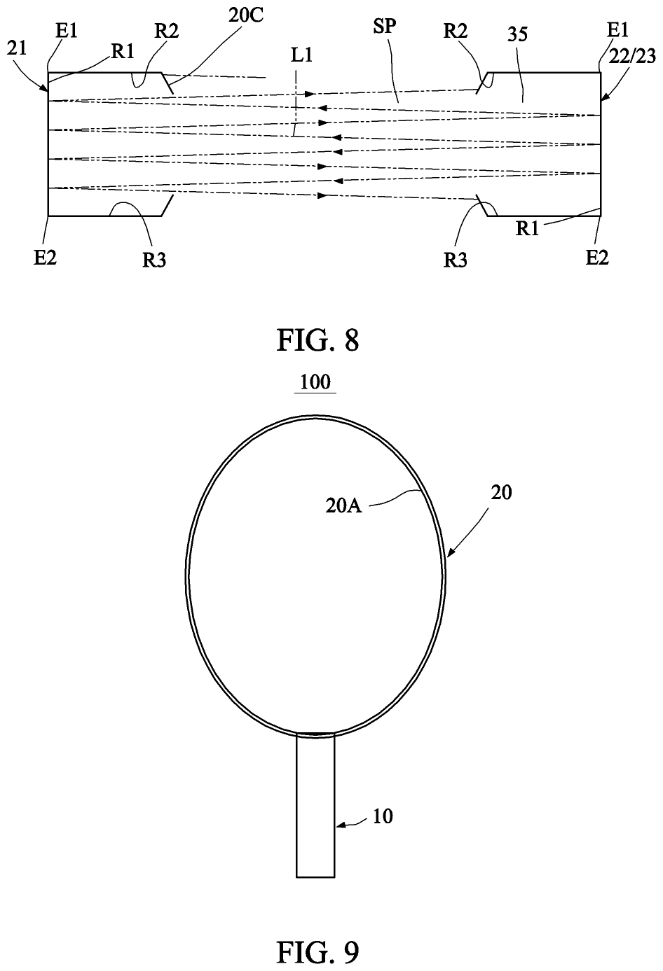

Referring to FIG. 7, the frame 20 further has an outer reflective structure 20B, which is connected to the first horizontal reflective surface R2 and the second horizontal reflective surface R3 and reflects the light L1 away from the space SP. Referring to FIG. 8, the frame 20 further has a light-absorbing structure 20C, which is connected to the first horizontal reflective surface R2 and the second horizontal reflective surface R3 and absorbs the light L1 to prevent the light from scattering randomly in the external environment. The light-absorbing structure 20C may be a black coating layer, a sawtooth structure, a rough surface, a porous material layer (such as a sponge layer) or a combination thereof. In another example, the angle of installation for the outer reflective structure 20B or the light-absorbing structure 20C can be adjusted to achieve the desired effect.

FIG. 9 is a schematic view showing a modified example of the dust inspection device of FIG. 1. Referring to FIG. 9, the inner reflective structure 20A is egg-shaped or has a shape similar to a close curve so that the inner reflective structure 20A is similar to a mosquito swatter, a badminton racket or a tennis racket. Therefore, the shape of the frame 20 may be any appropriate shape.

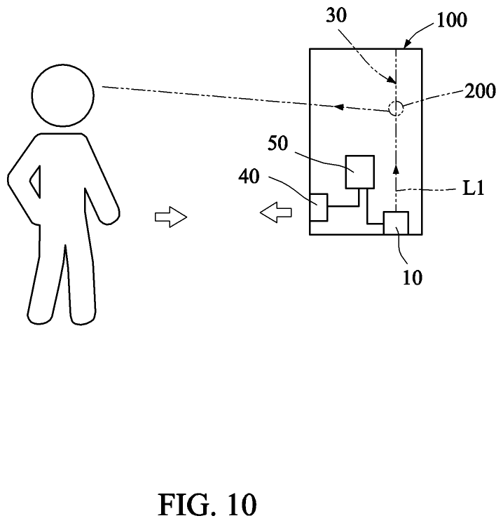

FIG. 10 is a schematic view showing another modified example of the dust inspection device of FIG. 1. Referring to FIG. 10, the dust inspection device 100 may be mounted on the ground, the wall, the machine or any other structure. The dust inspection device 100 further includes a detector 40 and a controller 50. The detector 40 outputs a start signal upon detecting the user entering a range of seeing the dust 200 passing through the optical net 30. In one example, the detector 40 outputs infrared light and receives reflected infrared light to generate the start signal. The controller 50, electrically connected to the detector 40 and the light-emitting module 10, enables the light-emitting module 10 to generate the light L1 and the optical net 30 according to the start signal. When the user is not within the range, the light-emitting module 10 may be disabled to turn off the light source and save the energy.

With the dust inspection device of the embodiment, the users can immediately inspect whether dust is present or not with their eyes. For example, the user can easily hold and swing the dust inspection device in the cleanroom to immediately check whether the dust is present therein or not. Of course, ordinary users may also use the dust inspection device to immediately inspect the levels of dust pollution in indoor or outdoor environments, allowing them to turn on an air purifier indoors or wear a mask outdoors, thereby maintaining respiratory health. Furthermore, the dust inspection device can also be fixedly installed in the environment, and configured to activate its light source upon detecting the user entering his or her visual range, so that the user can perform the real-time inspection.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A dust inspection device, comprising:
a light-emitting module outputting light travelling in a light-emitting direction; and
a frame, wherein the light-emitting module is installed on the frame, the light forms an optical net in a space surrounded by the frame and the light-emitting module, the frame has a first opening and a second opening disposed opposite the first opening, dust enters the optical net from the first opening, the dust passing through the optical net reflects the light to an eye of a user through the first opening or the second opening, so that the user inspects the dust in an environment using the dust inspection device, and then the dust leaves the optical net and the frame from the second opening.

2. The dust inspection device according to claim 1, wherein the frame has an inner reflective structure for reflecting the light to travel in the space.

3. The dust inspection device according to claim 2, wherein the frame further has an outer reflective structure for reflecting the light to travel out of the space.

4. The dust inspection device according to claim 2, wherein the frame further has a light-absorbing structure for absorbing the light.

5. The dust inspection device according to claim 2, wherein in a top view, the inner reflective structure has a polygonal shape.

6. The dust inspection device according to claim 5, wherein in the top view, the frame has a substantially triangular shape, and a first end of the light-emitting module is disposed on a vertex of the substantially triangular shape.

7. The dust inspection device according to claim 6, wherein the frame has a first reflective surface, a second reflective surface and a third reflective surface, the first end of the light-emitting module is disposed in a mounting hole formed on a connection portion of the second reflective surface and the third reflective surface, and the light-emitting direction is a direction from the mounting hole to the first reflective surface.

8. The dust inspection device according to claim 7, wherein the first reflective surface reflects the light to the second reflective surface and the third reflective surface, wherein the light has been repeatedly reflected by the first reflective surface, the second reflective surface and the third reflective surface, the optical net extends in a top view direction to generate an optical detection space having a predetermined thickness, and to increase an opportunity that the user senses the dust.

9. The dust inspection device according to claim 7, wherein each of the first reflective surface, the second reflective surface and the third reflective surface comprises:
a vertical reflective surface; and
a first horizontal reflective surface and a second horizontal reflective surface respectively connected to an upper edge and a lower edge of the vertical reflective surface, wherein the first horizontal reflective surface and the second horizontal reflective surface restrict a portion of the light from leaving the space and directly travelling to the eye of the user.

10. The dust inspection device according to claim 1, further comprising:
a detector outputting a start signal upon detecting the user entering a range of seeing the dust passing through the optical net; and
a controller, which is electrically connected to the detector and the light-emitting module, and enables the light-emitting module according to the start signal.

11. The dust inspection device according to claim 1, wherein the light-emitting module has a gripping structure to be held by the user so that the user can swing the dust inspection device to perform inspecting.

12. The dust inspection device according to claim 1, wherein the light is linear parallel light or diverging fan-shaped light generated by a light source passing through a lens.
